(19) United States
(12) Patent Application Publication
(10) Pub. No.: US 2021/0392811 A1
(43) Pub. Date: Dec. 23, 2021

(54) TOOL TO REMOVE WEEDS

(71) Applicant: Yoshio Yanez, San Bernadino, CA (US)

(72) Inventor: Yoshio Yanez, San Bernadino, CA (US)

(21) Appl. No.: 17/348,809

(22) Filed: Jun. 16, 2021

Related U.S. Application Data
(60) Provisional application No. 63/041,316, filed on Jun. 19, 2020.
(60) Provisional application No. 63/060,519, filed on Aug. 3, 2020.

(51) Int. Cl. A01D 9/02; A01G 3/00

(52) U.S. Cl. CPC A01D 9/02; A01G 3/00

(57) ABSTRACT

A garden tool is comprised of a handle and a head having a plurality of parallel tines each having a free end. The garden tool also has a span perpendicular to the tines. The span is connected to each of the tines at an intermediate position along the length of each tine. The span has a sharpened edge configured to sever plant growth.

### CROSS-REFERENCE TO RELATED APPLICATIONS

This application claims the benefit of U.S. Provisional Patent Application No. 63/041,316, filed on Jun. 19, 2020, entitled “Tool to remove weeds,” and of U.S. Provisional Patent Application No. 63/060,519, filed on Aug. 3, 2020, entitled “Tool to remove weeds”, which is hereby incorporated by reference in its entirety for all that is taught and disclosed therein.

### FIELD OF THE INVENTION

The present invention relates to tool which may be used by a professional or home gardener to remove weeds and other unwanted plants that invariably grow in gardens and landscapes about a home or commercial site.

### BACKGROUND AND SUMMARY

Traditional garden tools are made to be specific to one task; for example, a weed eater removes weeds over a large area.

However, a weed eater cannot target a small area and remove a few weeds at a time.

The above disadvantages are addressed by a garden tool that is comprised of a handle and a head having a plurality of parallel tines each having a free end. The garden tool also has a span perpendicular to the tines. The span is connected to each of the tines at an intermediate position along the length of each tine. The span has a sharpened edge configured to sever plant growth.

### BRIEF DESCRIPTION OF THE DRAWINGS

FIGS. 1-21 show various views of a preferred embodiment of the invention.

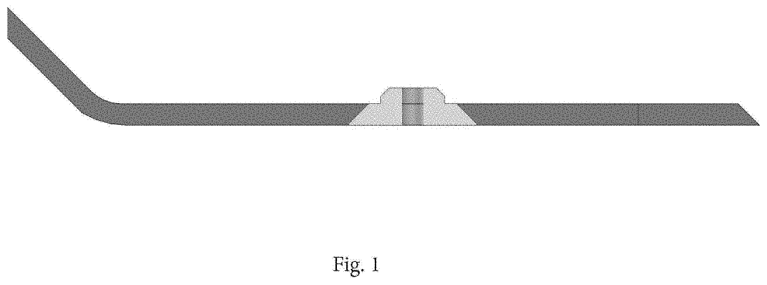

### DETAILED DESCRIPTION OF A PREFERRED EMBODIMENT

The following description of the preferred embodiment(s) is merely exemplary in nature and is in no way intended to limit the invention, its application, or uses.

The present invention is directed towards a tool that may be used by professional or home gardeners to remove weeds and other unwanted plants that invariably grow in gardens and landscapes about a home or commercial site.

A first embodiment of the tool is displayed in FIG. 5. Tool has a handle that is optimally set to allow the operator of tool to utilize the maximum amount of upper body strength to use tool. Handle may be constructed of wood, metal or other high strength material and may be fitted with rubber padding, finger grooves, or end to facilitate the use of tool by the operator. Handle is attached to head by a screwing action or friction fit and is then set by a pin or some other locking mechanism.

Tined head may be constructed as a single piece. Head has attached to it a plurality of tines. FIG. 5 shows three possible versions with different numbers of tines. Tines must number at least two. Perpendicular to tines and set midway along the length of the tines is span with cutting edges. In the first embodiment of tool, the span has a sharpened leading edge.

Tool functions by being positioned adjacent to a plant that is to be removed and is then moved rapidly towards the plant by the operator of the tool along the surface of the ground. As tool approaches the plant, tines come into contact with low lying leaves or runners from the plant that is to be removed as well as leaves or runners from other nearby plants. Tines moving along the surface of the ground, will act to lift these low-lying leaves or runners exposing the main stem of the plant. As tool continues to be moved forward, the leading sharpened edge of the span comes into contact with the stem and severs the stem. The operator then retracts tool and repositions tool adjacent to another plant that is to be removed and repeats the process.

The tips of tines may be varied with a high or low slope value. The tip of a tine may also be a point. It may be advantageous to form the tips of the outermost tine as a point, so that when tool is rotated 90 degrees, a tine configured with a pointed tip may be used to target unwanted plants that are found in tight spaces such as in cracks between two slabs of cement tiles. Other configurations for the tips of tines may be envisioned by those skilled in the art that are within the scope of this invention.

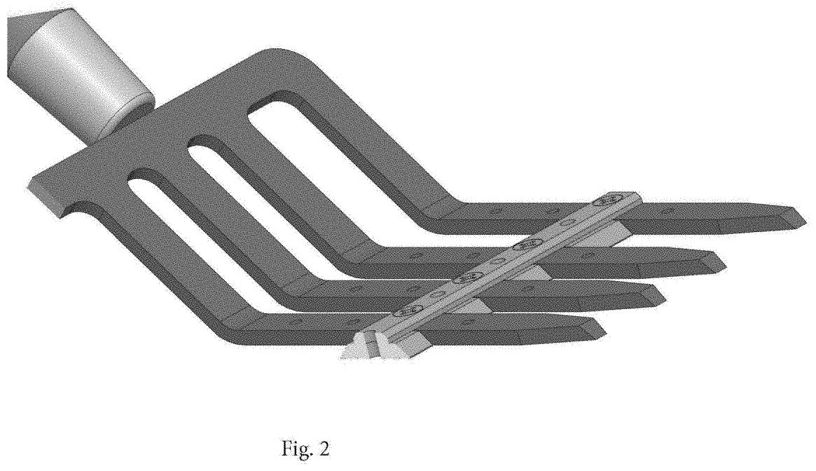

Span is shown in FIG. 2 as traversing tines in a direction that is perpendicular to tines. In other embodiments appreciated by those skilled in the art, span may also traverse tines at any number of angles, positive or negative, to tines. Span may have either its forward or rearward edge sharpened or it may have dual sharpened edges at both its forward edge and its rearward edge as shown in FIG. 2. A span configured with dual sharpened edges will allow for the rearward edge to be used as a forward edge when span is removed, rotated, and reattached to tines.

FIG. 2 shows an ISO view of tool with handle attached to head. Head is shown connected to tines as a single piece but this arrangement may be comprised of multiple pieces. Span cutting edges may be positioned above, flush with, below, or some other orientation to tines. FIG. 2 shows span cutting edge flush with the bottom edge or tines. One skilled in the art will appreciate the fact that handle must be at an appropriate angle to minimize the loss of power between the operator of tool and tool itself.

Span is shown in FIG. 2 as being attached to each tine by a screw. Other means and arrangements of connecting span to tines so that span may be detached and reattached to tines may be appreciated by one skilled in the art. As span is used, its leading edge will become dull. To resolve this problem the operator may (i) remove span and replace it with another span that is sharpened and ready for use, (ii) remove span, resharpen its forward edge, then reattach span to tines, or (iii) if span is sharpened both on its forward and rearward edge as shown in FIG. 2, remove span, rotate span so that the rearward edge becomes the forward edge, and then reattach span to tines.

Another embodiment of the tool to remove weeds vary the angular direction of handle allowing the operator to use a pulling instead of a pushing action. It will also be appreciated by one skilled in the art that head may be constructed with a swivel mount so that handle may be changed by the operator from a pushing configuration to a pulling configuration.

Another embodiment of the tool would have a variety of spacing between the tines. It will be appreciated by one skilled in the art, that it is not necessary that tines are equidistant with each other as shown in FIG. 2. It may be beneficial for the centermost tines to be spaced closer to each other rather than being equidistant with all of the tines.

Another embodiment of the tool might have tines which are set at angles to one another rather than being parallel.

It is not necessary that the span go across all of the tines.

In FIG. 2 tines are comprised of two segments with an acute angle between the segments. Another embodiment might have tines composed of two segments with an obtuse angle between the segments.

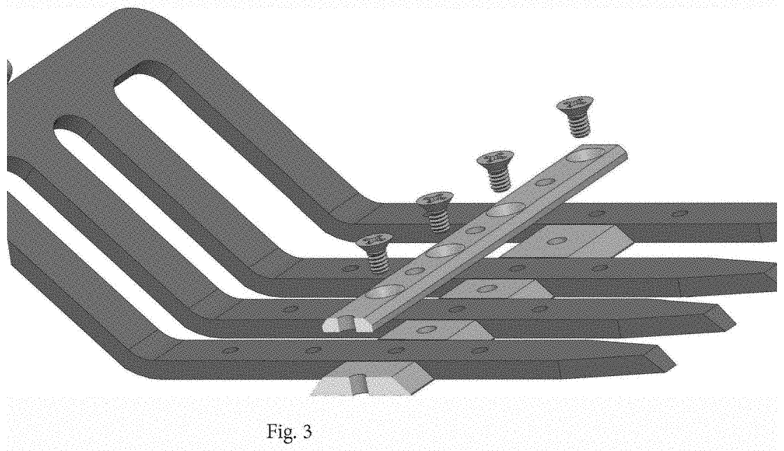

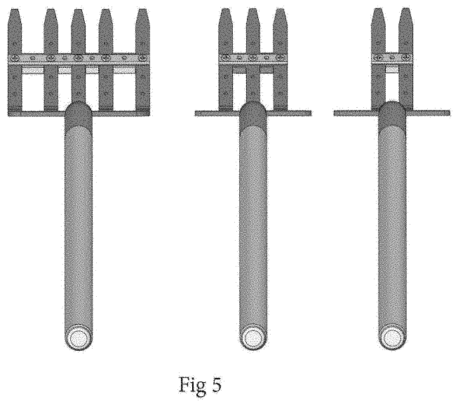

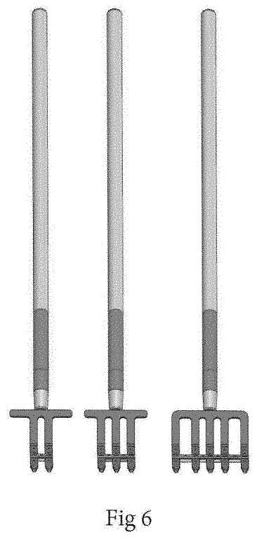

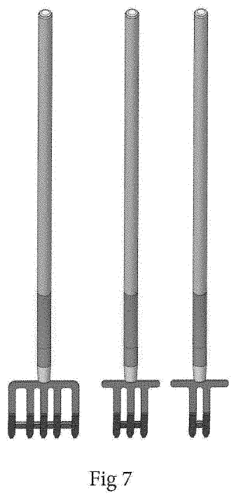

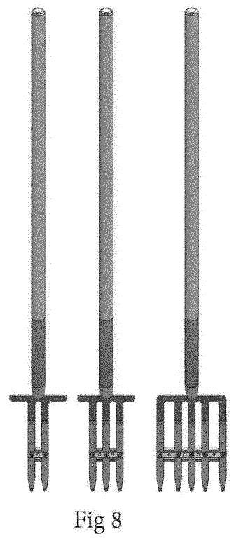

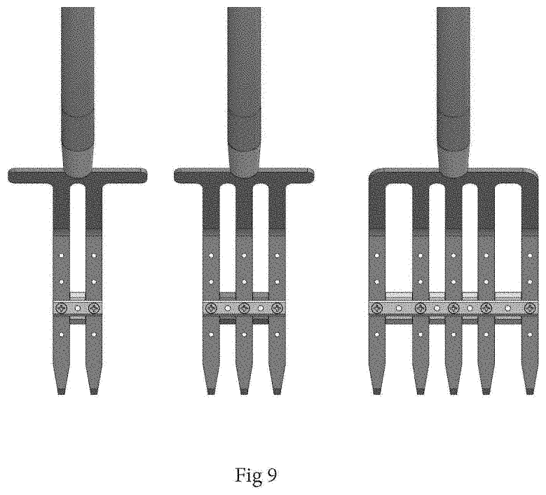

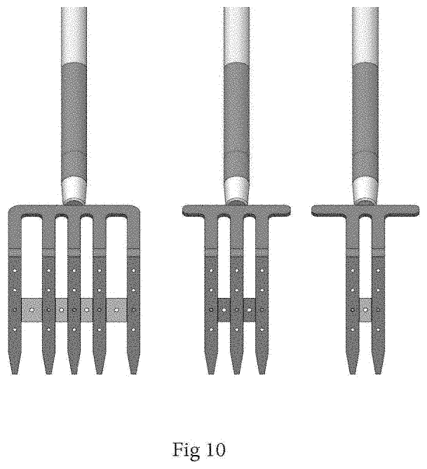

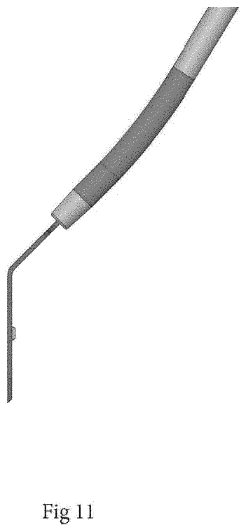

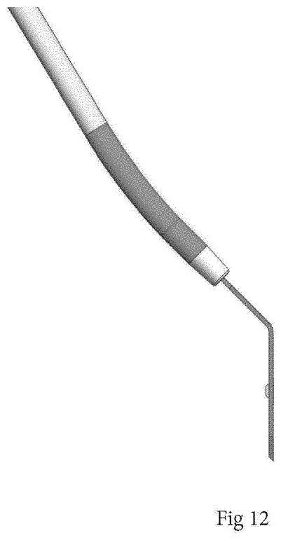

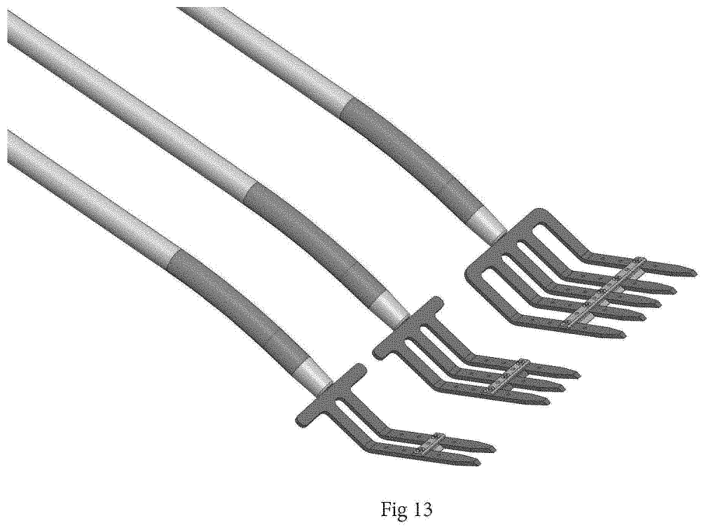

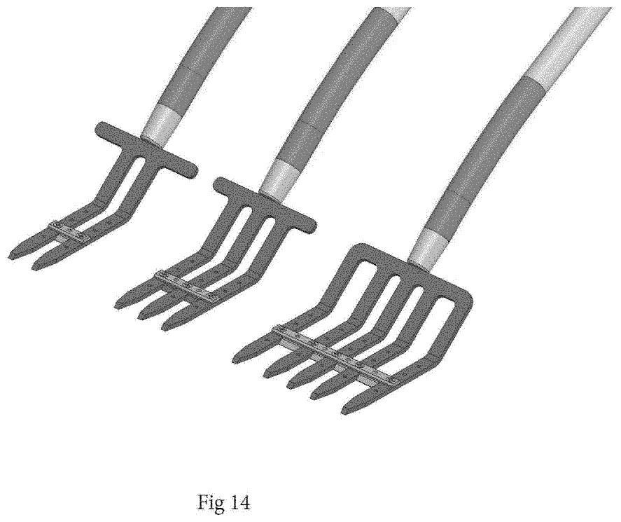

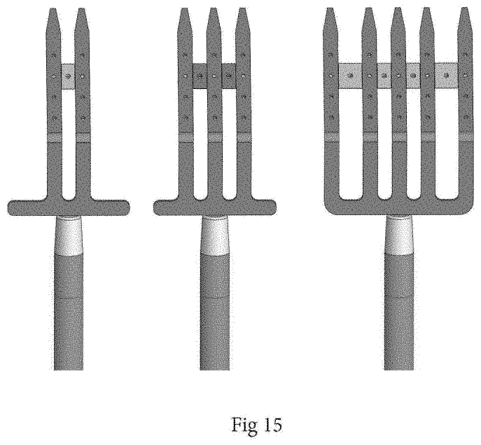

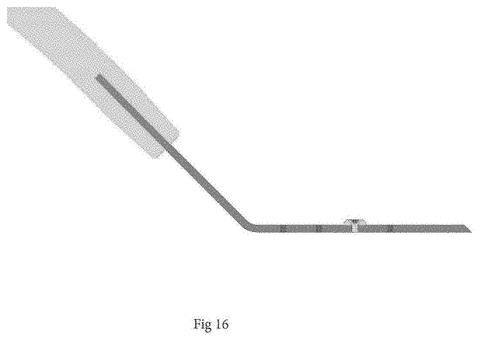

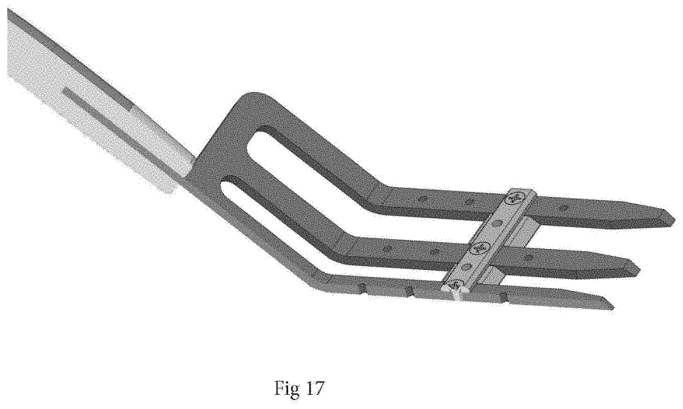

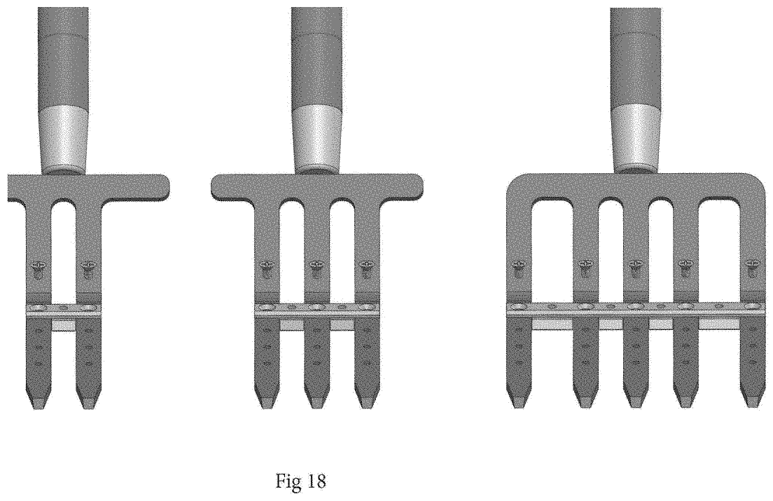

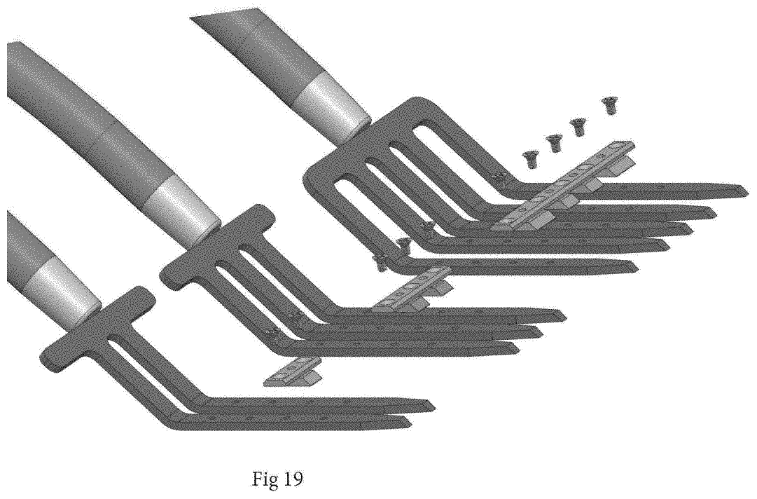

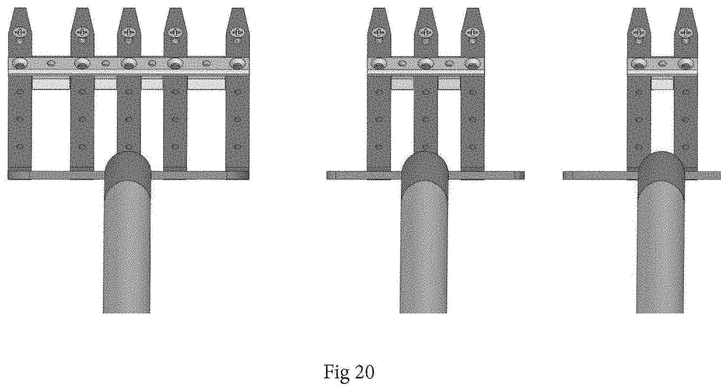

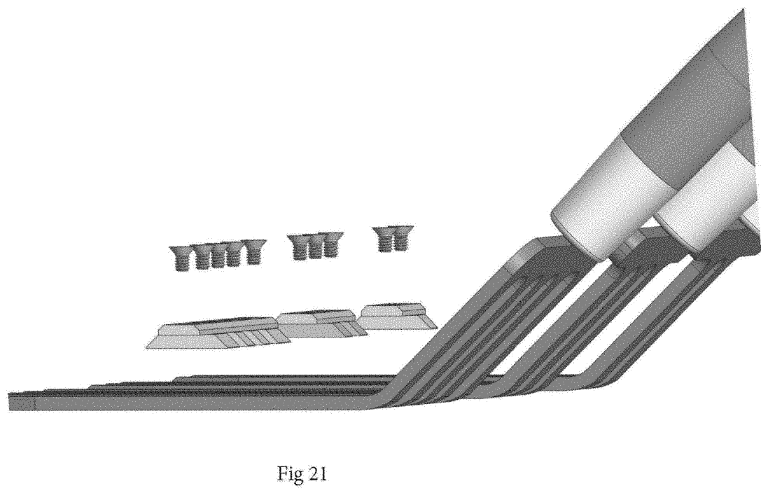

FIG. 3 is an exploded view of the tool showing that the span is attached to the tines by screws. During use, span will become dull and will require resharpening. By removing the screws span may be separated from tines to be sharpened and returned to tool by reversing the process.

The foregoing description of the preferred embodiments of the invention have been presented for the purposes of illustration and description. It is not intended to be exhaustive or to limit the invention to the precise form disclosed. Many modifications and variations are possible in light of the above teaching.

I claim:

1. A garden tool comprising:
a handle;
a head having a plurality of parallel tines each having a free end;
a span perpendicular to the tines;
the span connected to each of the tines at an intermediate position along the length of each tine;
the span having a sharpened edge configured to sever plant growth.
